(19) United States
(12) Patent Application Publication
(10) Pub. No.: US 2009/0049720 A1
(43) Pub. Date: Feb. 26, 2009

(54) Marketing/advertising methods using lunch bags

(75) Inventors: Debra Cohen, Hewlett, NY (US); Pam Rottenberg, Parkland, FL (US)

Correspondence Address: FRISHAUF, HOLTZ, GOODMAN & CHICK, PC, 220 Fifth Avenue, 16TH Floor, NEW YORK, NY, 10001-7708, US

(73) Assignee: LUNCHBAGZ, LLC, Hewlett, NY (US)

(21) Appl. No.: 11/894,318

(22) Filed: Aug. 21, 2007

(51) Int. Cl. G09F 21/02

(52) U.S. Cl. 40/586

(57) ABSTRACT

Method for conducting a marketing/advertising campaign using lunch bags includes determining at least one product or service to be advertised, determining graphic matter to be placed onto at least one face of the lunch bag, placing the graphic matter onto the face(s) of the lunch bag, identifying targeted users of the advertised product(s) or service(s) and providing the lunch bag having the graphic matter thereon only to the targeted users. Lunch bags can thus be used to effectively deliver advertisements to their customary users, i.e., children. Appropriate determination of the graphic matter based for example, on the age of the targeted children, and/or identification of the targeted users can optimize the effect of the advertisement.

### FIELD OF THE INVENTION

The present invention relates generally to a method for conducting an advertising campaign using lunch bags.

### BACKGROUND INFORMATION

Children are subjected to various forms of advertisements. Most notably, television programs for children have a significant number of advertisements.

However, television advertisements do not reach all children because, for example, some children do not watch television. Moreover, some children watch television programs from program recording devices which record the programs at an earlier time and remove the advertisements to enable the children to watch the programs advertisement-free.

Lunch bags have been used as an advertising medium and in this regard, U.S. Patent Application Publication No. 2005/0061707 (Naelitz-Thomas) describes themed lunch bags which may include an advertisement. However, Naelitz-Thomas does not disclose how the advertisement to be placed onto the lunch bag is selected. As a result, it is possible that lunch bags containing advertisements directed to specific age children are used by different age children or possibly even by adults.

It would therefore be desirable to enable an advertiser to market and advertise a product or service to specific age children in a manner which will virtually guarantee that these children are exposed to the advertisement.

### OBJECTS AND SUMMARY OF THE INVENTION

A general object of the present invention is to provide a method for enabling an advertiser to market and advertise a product or service for children in a manner which will ensure that the children are exposed to the advertisement.

In order to achieve this object and others, a method for conducting a marketing/advertising campaign using lunch bags in accordance with the invention includes determining at least one product or service to be advertised, determining graphic matter to be placed onto at least one face of the lunch bags, placing the graphic matter onto the face(s) of the lunch bag, identifying targeted users of the advertised product(s) or service(s) and providing the lunch bags having the graphic matter thereon only to the targeted users. In this manner, lunch bags can be used to effectively deliver advertisements to specific, targeted users, and in particular, the customary users of such lunch bags, children. More particularly, the lunch bags can be used to deliver advertisements to elementary school children 5-12 years old. Appropriate determination of the graphic matter and/or identification of the targeted users can optimize the effect of the advertisement.

In one embodiment, the graphic matter relates to the advertised product or service. For example, the graphic matter may be a coupon for the advertised product or service. The graphic matter may also be one or more games, puzzles and/or contests, possibly relating to the advertised product or service or company marketing the advertised product or service.

Different graphic matter can be placed onto the lunch bags, for the same product or service or for different products or services marketed by the same advertiser or possibly even different advertisers. All of the advertised products or services should have the same targeted users. The different lunch bags are then packaged together and provided to the targeted users so that they now have different lunch bags and would be more inclined to look at the lunchbags anew during every use.

When providing the lunch bags to the targeted users in a package, which may be accomplished, for example, through the mail or other postal delivery service, a sample of the product or a coupon, contest or promotion can be included or incorporated into the same package.

### BRIEF DESCRIPTION OF THE DRAWINGS

The invention, together with further objects and advantages thereof, may best be understood by reference to the following description taken in conjunction with the accompanying drawings, wherein like reference numerals identify like elements, and wherein:

FIG. 1 is an illustration of an exemplifying lunchbag which is used in advertising methods in accordance with the invention.

FIG. 2 is a flow chart of an exemplifying advertising method using lunch bags in accordance with the invention.

### DETAILED DESCRIPTION OF THE INVENTION

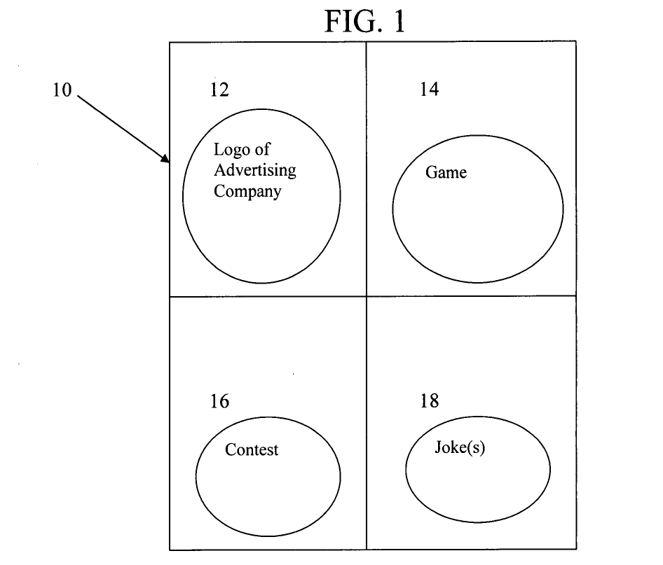

Referring to the accompanying drawings wherein the same reference numerals refer to the same or similar elements, FIG. 1 shows an exemplifying embodiment of a lunch bag 10, which is used in advertising methods and arrangements in accordance with the invention. The lunch bag 10 in accordance with the invention has the typical form of a lunch bag for primary use for carrying lunch for school-age children. Thus, they are preferably formed from a single sheet of paper which is foldable into the form of a bag having a rectangular front face, a rectangular rear face having substantially the same dimensions as the front face, opposed, rectangular side faces having substantially the same dimensions and extending between the front and rear faces, and a bottom face extending between the lower edges of the front, rear and side faces. Where necessary, adhesive is applied to the faces. The lunch bag 10 has an initial, closed and packaging configuration, well-known to children and others, an open configuration in which objects such as food can be placed into an interior compartment defined by the faces, and a use configuration in which the front and rear faces are preferably folded over to close the food-containing interior compartment. While a single sheet of paper is preferable, it is envisioned that multiple pieces of paper could be combined together to form the bag, or other known materials such as plastics could be utilized.

In the illustrated embodiment, lunch bag 10 includes a plurality of different graphic matter-containing areas 12, 14, 16, 18 on one of the front and rear faces, each area 12, 14, 16, 18 including a particular feature. Further, it is conceivable that additional areas are formed on the side faces and possibly even the bottom face. Thus, any portion or all of the faces of the lunch bags can be considered as a graphic matter-containing area.

Moreover, although the lunch bag 10 shown in FIG. 1 has four graphic-matter containing areas on a front or rear face, it is contemplated that a lunch bag in accordance with the invention may have any number of graphic-matter containing areas, even only a single area occupying an entire front or rear face of the lunch bag. A clear demarcation between the different areas is not required and the content of the graphic matter-containing areas 12, 14, 16, 18 can be merged together if so desired.

Some features include artwork, logos and games. At least one of the features and possibly even all of the features relate to the advertising company, advertised brand, or the advertised product or service. For example, area 12 may include artwork or a logo of a trademark of the advertising company or advertised product. Area 14 may include a game possibly relating to the advertising company, such as a word search in which the words to be found are all products of the advertising company. Other possible games include puzzles or rebuses. Area 16 may include a contest or promotion sponsored by the advertising company. Area 18 may include one or more jokes, possibly relating to the advertising company or advertised product or service.

There are numerous ways to create the lunch bags 10, for example, different materials may be used, different colors of materials, etc. In one embodiment, each lunch bag 10 is created from a sheet of white Kraft paper, and printed on with multiple colors, e.g., four colors, to obtain the different features in areas 12, 14, 16, 18. Environmentally-conscious advertisers could choose to use partly or entirely recycled paper. It has been found that recyclable paper content works well.

It is envisioned that the lunch bags 10 can be used in a targeted marketing/advertising campaign targeted to children of specific ages or age ranges. Corporations, manufacturers of products or providers of services intended for use by children can promote products or services using the lunch bags 10. Possible products and services which can be advertised include toys, movies, characters, stores, food products, theme parks, professional sports teams, etc. A promotion would be placed in one or more of the areas 12, 14, 16, 18, either as a stand-alone promotion or a promotion incorporated into a game, puzzle, rebus, word search, etc.

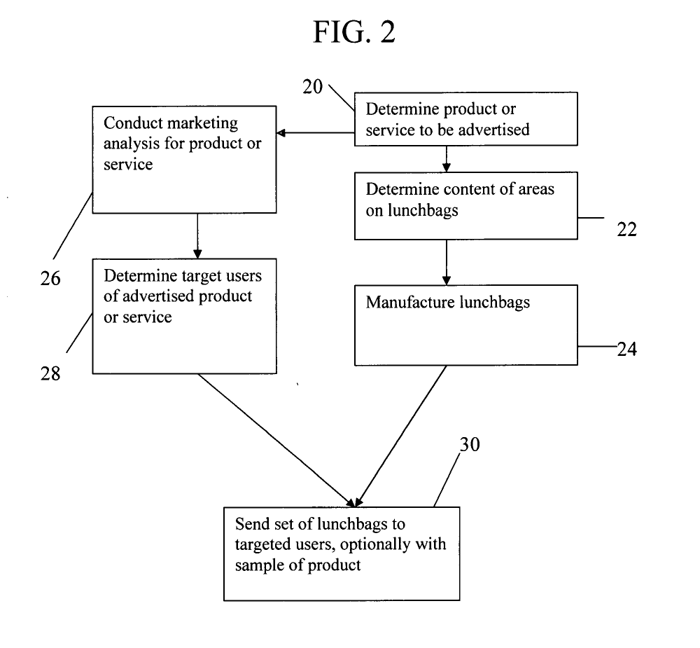

In an exemplifying embodiment of the method for conducting such a marketing/advertising campaign, a flow chart of which is shown in FIG. 2, the advertiser first determines the product or service to be advertised, 20. It is understood that the advertiser may want to advertise multiple products and/or multiple services, or combinations of products and services, and that these are also contemplated to be within the scope and spirit of a marketing/advertising method in accordance with the invention. For the sake of simplicity, this example will be limited to marketing/advertising a single product or service.

Once the advertiser determines the product or service to be advertised, the content of the graphic matter-containing areas 12, 14, 16, 18 of the lunch bag 10 is determined, 22. The lunch bags 10 are then manufactured with the determined content, 24.

In one embodiment of the invention, different lunch bags 10 are created for the same advertised product or service, or for different products or services sold or provided by the same advertiser. By different lunch bags 10, it is meant that the graphic matter placed onto each of the plurality of lunch bags is different, whether the graphic matter relates to the same advertised product or services, or different products or services sold by the same advertiser.

A number of the lunch bags 10 are then packaged together, e.g., five, one for each day of the week, or twenty to cover a four-week period. Any number of lunchbags can be packaged together. The number could be based on, for example, the demographics of each targeted user so that some users may receive a different number of lunch bags than other targeted users.

The manner in which the lunch bags 10 are packaged together may be any known technique known in the packaging field, including but not limited to shrink-wrapping. It is preferable that the lunch bags are bound in clear see-through packaging so that at least some of the graphics on at least some of the bags is visible.

When different lunch bags 10 are created, the different lunch bags are packaged together so that there would be, for example, five unique and different lunchbags 10 in a single package. If the advertiser is advertising multiple products or services, all of the advertised products or services should be targeted to the same users since they will be packaged together and sent to those targeted users.

Referring again to FIG. 2, a marketing analysis of the product or service to be advertised is conducted, 26, and based thereon, the targeted users of the product or service being advertised are determined, 28. For a product for use by children, the targeted users would be the children who would use the product and persons who purchase the product for the children (i.e., parent or guardian). Any characteristics of the children can be used to determine the targeted users, including but not limited to, age, sex, school, location, other demographic indicators. Any known technique or techniques can be used to conduct the marketing analysis and determination of targeted users. Indeed, one skilled in the art of targeted advertising and marketing would be familiar with the manners in which these steps are performed. Determination of the targeted users would at a minimum provide the mailing addresses of the users.

Once the targeted users are determined, the lunch bags 10 are labeled, sorted if necessary and provided to the targeted users 30, for example, by mail. Optionally, if the advertised item is a product conducive to mailing, the product itself could also be included in a package of lunch bags being sent to the targeted users. Alternatively, if it is undesirable or impractical to send the product to the targeted users, e.g., the product is too large for mailing, a sample or sample size of the product, or a coupon for a free product can be included in the package of lunch bags being sent to the targeted users. While in the preferred embodiment the lunch bags are provided to the targeted users by mail, it is envisioned that the lunch bags could instead be distributed for free at movie theaters, schools, theme parks, sporting events, an advertiser's place of business or a retail store which sells the advertiser's goods/services, in a cereal box, or other food products which are capable including the lunch bags within or in conjunction with the packaging.

In addition to or instead of the product or a sample thereof being included in or with the package of lunch bags being sent to the targeted users, a coupon, contest or promotion may be included. The coupon, ideally for the advertised product or service, could be printed on the lunchbag 10 itself or attached thereto. One type of contest is an art contest, the details of which would be included in the mailing being sent to the targeted users, or details about an on-line promotion could be included in the mailing. Alternatively, the lunch bags may include a code to be input at a website to enable the targeted user to receive a free offer, such as more lunch bags. The contest or promotion could, but is not required to, relate to the advertising company or advertised product or service.

The product, sample of the product, details of the contest or details of the on-line promotion would be included with the mailing by, for example, shrink-wrapping in a common package with the lunch bags.

There are several advantages provided by a marketing/advertising campaign conducted using lunch bags as described above.

One advantage of the invention is that children (and parents if a parent packs the child's lunch) can be targeted by advertisements when they constitute a captive audience in their primary social networking environment. That is, the children invariably eat lunch every day while they attend school and thus a cafeteria or lunchroom in the school or other educational facility becomes their primary social networking environment. Each child brings their lunchbag to the cafeteria or lunchroom and their lunch bag, and the advertisement(s) thereon, would be viewed by the child and other children eating in proximity to the child. In this manner, by placing one or more advertisements on a single lunch bag, an advertiser can expose multiple children to the same advertisement(s), and can expose the parent or guardian who prepares the child's lunch. Since both the parent and child see the advertisement, the two components to the purchase of a product have been exposed to the product/service (i.e., the child who must desire the product/service and the parent who must purchase the product/service for the child). This is not achieved by more traditional marketing/advertising wherein only one of the parent/child is exposed to the marketing/advertising (e.g., children's television advertisements, parent's television or magazine advertisements).

Moreover, since children usually eat with other children their age, an age-appropriate advertisement on one child's lunch bag will be viewed by other children of the same age. This is important since the product or service being advertised is expected to vary from one lunchbag to another and some products or services may be best targeted to specific age children.

In this manner, the invention overcomes a drawback of prior art lunch bags with fixed advertisements. With such prior art lunch bags, all children using the lunch bags and all other children viewing such lunch bags will be exposed to the same product or service being advertised, regardless of whether that product or service is appropriate for or being targeted to children their age. By contrast, the invention enables age-based marketing/advertising campaigns whereby one or more advertisements are placed on lunch bags for a specific age or ages of children while other advertisements, whether for the same or different products or services, are placed on lunch bags for other specific age or ages of children.

Another advantage of the invention is that by exposing children to advertisements in their primary social network, the children may, upon viewing the advertisements, discuss the advertised products or services. In this manner, the advertising message will not only reach a large number of children who actually view the advertisements, but also other children to whom the advertising message is subsequently spread.

Having described exemplary embodiments of the invention with reference to the accompanying drawings, it will be appreciated that the present invention is not limited to those embodiments, and that various changes and modifications can be effected therein by one of ordinary skill in the art without departing from the scope or spirit of the invention as defined by the appended claims.

1. A method for conducting a marketing/advertising campaign using a lunch bag, comprising:
determining at least one product or service to be advertised;
determining graphic matter to be placed onto at least one face of the lunch bag;
placing the graphic matter onto the at least one face of the lunch bag;
identifying targeted users of the at least one advertised product or service; and
providing the lunch bag having the graphic matter thereon only to the targeted users.

2. The method of claim 1, wherein the step of determining the graphic matter comprises creating graphic matter relating to the advertised product or service.

3. The method of claim 1, wherein the step of determining the graphic matter comprises creating a coupon for the advertised product or service.

4. The method of claim 1, further comprising partitioning the at least one face into a plurality of areas, the step of determining graphic matter to be placed onto at least one face of the lunch bag comprising determining graphic matter to be placed into each of the plurality of areas.

5. The method of claim 1, wherein the step of determining graphic matter to be placed onto the at least one face of the lunch bag comprises creating at least one game, puzzle or contest relating to the advertised product or service or company marketing the advertised product or service.

6. The method of claim 1, further comprising selecting the advertised product or service from a group consisting of a toy, movie, character, store, theme park, or food product.

7. The method of claim 1, wherein the at least one product or service to be advertised comprises a plurality of products or services having the same targeted users.

8. The method of claim 1, wherein the step of determining graphic matter to be placed onto at least one face of the lunch bag comprising determining a plurality of different graphic matter to be placed onto different lunch bags.

9. The method of claim 8, further comprising packaging a plurality of the different lunch bags together in a single package, the single package of different lunch bags being provided to the targeted users.

10. The method of claim 9, wherein the at least one product or service to be advertised comprises a single product or service such that different lunch bags for the single product or service are provided to the targeted users.

11. The method of claim 1, further comprising packaging a plurality of the lunch bag together in a single package, the step of providing the lunch bags to the identified targeted users comprising providing the single package comprising a plurality of lunch bags to the targeted users.

12. The method of claim 11, further comprising determining the number of lunch bags to include in each package to a targeted user based on characteristics of the targeted user.

13. The method of claim 1, wherein the step of providing the lunch bag to the targeted users comprises one of mailing the lunch bag to each targeted user, or passing out lunch bags to each targeted user.

14. The method of claim 1, further comprising including the product or a sample of the product when providing the lunch bag to the targeted users.

15. The method of claim 1, further comprising including a coupon, contest or promotion when providing the lunch bag to the targeted users.

16. The method of claim 1 wherein the lunch bag is provided to the targeted users free of charge.
